(19) United States
(12) Patent Application Publication
(10) Pub. No.: US 2019/0293313 A1
(43) Pub. Date: Sep. 26, 2019

(54) SYSTEM OF HVAC FAULT DETECTION USING THERMOSTAT DATA

(71) Applicant: Carrier Corporation, Palm Beach Gardens, FL (US)

(72) Inventors: Hayden M. Reeve, West Hartford, CT (US); Daniel J. Dempsey, Carmel, IN (US); Xinyu Wu, Shanghai (CN); Sheng Li, Shanghai (CN); Xing Cai, Shanghai (CN)

(21) Appl. No.: 16/358,907

(22) Filed: Mar. 20, 2019

(30) Foreign Application Priority Data
Mar. 23, 2018 (CN) 201810249583.X

(51) Int. Cl. F24F 11/38; G05B 15/02; F24F 11/523

(52) U.S. Cl. CPC F24F 11/38; F24F 11/523; G05B 15/02

(57) ABSTRACT

A method of operating a heating, ventilation, and air conditioning (HVAC) analytics system is provided. The method comprising: obtaining HVAC data for an HVAC unit; obtaining an HVAC unit characteristic of the HVAC unit; determining performance parameters of the HVAC unit in response to the HVAC data and the HVAC unit characteristic; identifying one or more system models for the HVAC unit in response to the performance parameters; determining one or more HVAC performance indices in response to the one or more system models, HVAC data, and the HVAC unit characteristic; generating an HVAC performance report in response to the one or more performance indices; and transmitting the HVAC performance report to a user device.

### CROSS-REFERENCE TO RELATED APPLICATIONS

This application claims the benefit of Non-Provisional Chinese Application No. 201810249583.X filed Mar. 23, 2018, which is incorporated herein by reference in its entirety.

### BACKGROUND

The subject matter disclosed herein generally relates to heating, ventilation, and air conditioning (HVAC) systems, and more specifically to an apparatus and a method for monitoring a control system of an HVAC system.

Conventional HVAC systems are often designed with enough capacity allowance to maintain comfort in an enclosed area when operating at peak heating or cooling load conditions. However current systems are unable to predict when capacity may decrease to a point where the HVAC system is unable to maintain comfort in the enclosed areas.

### BRIEF SUMMARY

According to one embodiment, a method of operating a heating, ventilation, and air conditioning (HVAC) analytics system is provided. The method includes: obtaining HVAC data for an HVAC unit; obtaining an HVAC unit characteristic of the HVAC unit; determining performance parameters of the HVAC unit in response to the HVAC data and the HVAC unit characteristic; identifying one or more system models for the HVAC unit in response to the performance parameters; determining one or more HVAC performance indices in response to the one or more system models, HVAC data, and the HVAC unit characteristic; generating an HVAC performance report in response to the one or more performance indices; and transmitting the HVAC performance report to a user device.

In addition to one or more of the features described above, or as an alternative, further embodiments may include: activating an alarm when at least one of the one or more performance indices is outside of a selected range.

In addition to one or more of the features described above, or as an alternative, further embodiments may include that the one or more HVAC performance indices includes an indoor air temperature rate.

In addition to one or more of the features described above, or as an alternative, further embodiments may include that the HVAC performance reports includes the indoor air temperature rate over a selected period of time.

In addition to one or more of the features described above, or as an alternative, further embodiments may include that the one or more system models includes at least one of a system static model and a system dynamic model.

In addition to one or more of the features described above, or as an alternative, further embodiments may include that the one or more HVAC performance indices includes at least one of a capacity available ratio (CAR), a comfort outdoor air temp (OAT) limit, an indoor air temperature rate (IATR), and an IAT limit.

In addition to one or more of the features described above, or as an alternative, further embodiments may include that the HVAC data includes at least one of an IATR produced by the HVAC unit, an OAT proximate the HVAC unit, and a runtime of the HVAC unit.

According to an embodiment, a heating, ventilation, and air conditioning (HVAC) analytics system is provided. The HVAC analytics system includes: an HVAC system including an HVAC unit and a controller configured to deliver conditioned air to a targeted area; an HVAC analytics engine in electronic communication with the HVAC system. The HVAC analytics engine includes a processor, and a memory, and is configured to: obtain HVAC data; obtain an HVAC unit characteristic of the HVAC unit; determine performance parameters of the HVAC unit in response to the HVAC data and the HVAC unit characteristic; identify one or more system models for the HVAC unit in response to the performance parameters; determine one or more HVAC performance indices in response to the one or more system models, HVAC data, and the HVAC unit characteristic; generate an HVAC performance report in response to the one or more performance indices; and transmit the HVAC performance report to a user device.

In addition to one or more of the features described above, or as an alternative, further embodiments may include that the HVAC analytics engine is further configured to: activate an alarm when at least one of the one or more performance indices is outside of a selected range.

In addition to one or more of the features described above, or as an alternative, further embodiments may include that the one or more HVAC performance indices includes an indoor air temperature rate.

In addition to one or more of the features described above, or as an alternative, further embodiments may include that the HVAC performance reports includes the indoor air temperature rate over a selected period of time.

In addition to one or more of the features described above, or as an alternative, further embodiments may include that the one or more system models includes at least one of a system static model and a system dynamic model.

In addition to one or more of the features described above, or as an alternative, further embodiments may include that the one or more HVAC performance indices includes at least one of a capacity available ratio (CAR), a comfort outdoor air temp (OAT) limit, an indoor air temperature rate (IATR), and an IAT limit.

In addition to one or more of the features described above, or as an alternative, further embodiments may include that the HVAC data includes at least one of an IATR produced by the HVAC unit, an OAT proximate the HVAC unit, and a runtime of the HVAC unit.

In addition to one or more of the features described above, or as an alternative, further embodiments may include that the HVAC analytics engine is separate and apart from the HVAC unit, and the HVAC analytics engine is in electronic communication through a wireless communication network.

In addition to one or more of the features described above, or as an alternative, further embodiments may include that the HVAC analytics engine is embedded within at least one of the HVAC unit and a controller in communication with the HVAC unit.

According to another embodiment, a computer program product tangibly embodied on a computer readable medium is provided. The computer program product including instructions that, when executed by a processor, cause the processor to perform operations including: obtaining HVAC data for an HVAC unit; obtaining an HVAC unit characteristic of the HVAC unit; determining performance parameters of the HVAC unit in response to the HVAC data and the HVAC unit characteristic; identifying one or more system models for the HVAC unit in response to the performance parameters; determining one or more HVAC performance indices in response to the one or more system models, HVAC data, and the HVAC unit characteristic; generating an HVAC performance report in response to the one or more performance indices; and transmitting the HVAC performance report to a user device.

In addition to one or more of the features described above, or as an alternative, further embodiments may include that the operations further includes: activating an alarm when at least one of the one or more performance indices is outside of a selected range.

In addition to one or more of the features described above, or as an alternative, further embodiments may include that the one or more HVAC performance indices includes an indoor air temperature rate.

In addition to one or more of the features described above, or as an alternative, further embodiments may include that the HVAC performance reports includes the indoor air temperature rate over a selected period of time.

Technical effects of embodiments of the present disclosure include utilizing predicting capacity loss of HVAC unit in response to the rate of change of the indoor air temperature.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

The following descriptions should not be considered limiting in any way. With reference to the accompanying drawings, like elements are numbered alike:

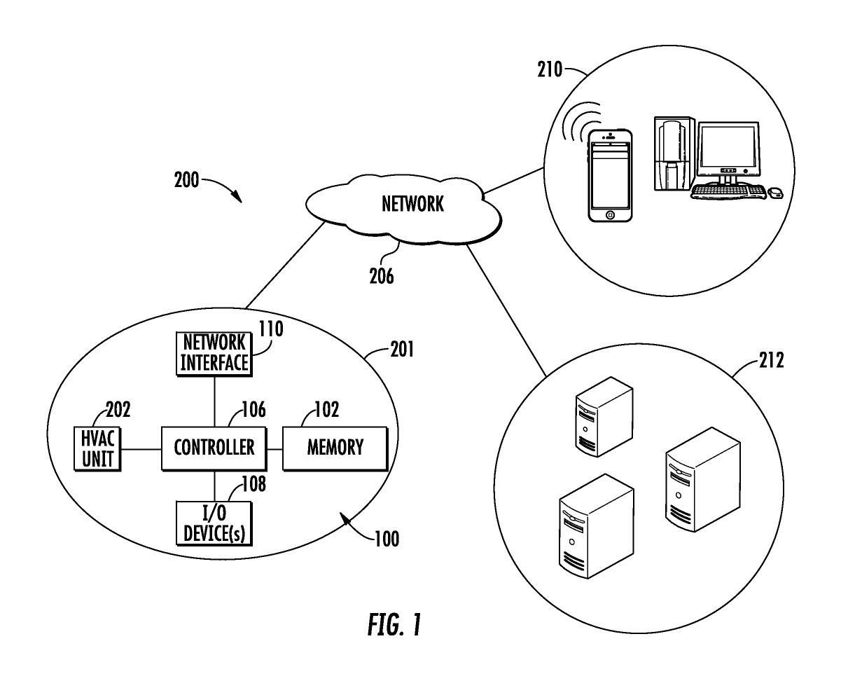

FIG. 1 illustrates a network-based HVAC system, according to an embodiment of the present disclosure;

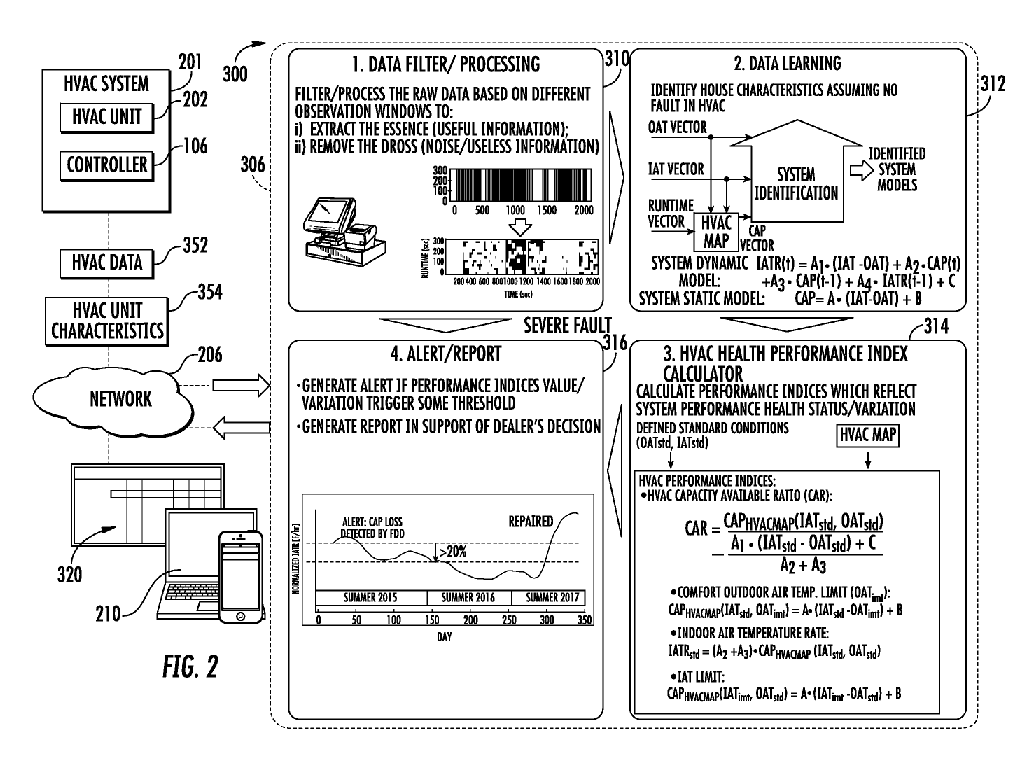

FIG. 2 illustrates an HVAC analytics engine, according to an embodiment of the present disclosure; and

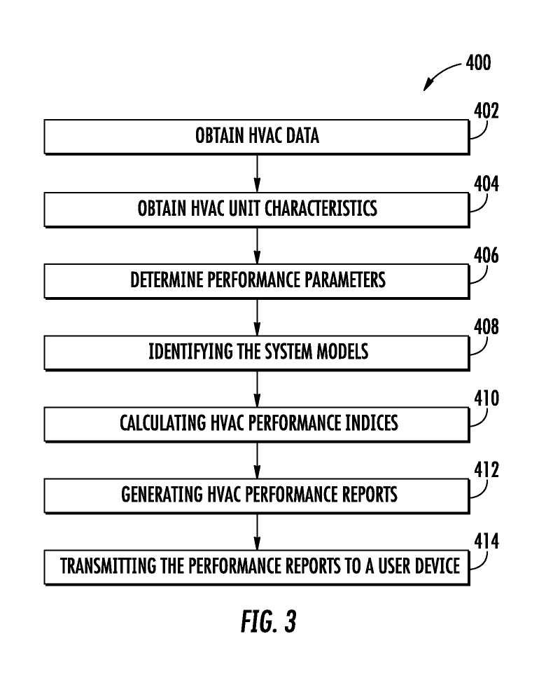

FIG. 3 is a flow diagram illustrating a method of operating an HVAC analytics engine, according to an embodiment of the present disclosure.

### DETAILED DESCRIPTION

A detailed description of one or more embodiments of the disclosed apparatus and method are presented herein by way of exemplification and not limitation with reference to the Figures.

Conventional HVAC control systems typically monitor only the temperature of one or more rooms in a building or house to operate an HVAC unit according to a target temperature set point value set by the user. However, various unknown system faults can cause degradation of the actual HVAC performance.

Early fault detection of HVAC system in advance of when homeowners begin to notice a comfort issue can provide value to homeowners and dealer service persons. Generally, homeowners may not be aware of performance issues with their HVAC system during mild weather seasons. HVAC systems may already be performing poorly without the homeowner's knowledge due to a variety of HVAC issues including but not limited to a refrigerant leak, improperly sized equipment, house envelope leakage, . . . etc. The comfort issues may arise once the HVAC issues get worse and/or peak load conditions exist (hot summer and/or cold winter). Once peak conditions exist, homeowners may have difficulty having their HVAC unit serviced due to an increased number of HVAC dealer/contractor service calls.

Various non-limiting embodiments of the disclosure provide an HVAC analytics engine configured to automatically analyze historical HVAC operational data and detect HVAC fault in advance of any comfort issue and then report the HVAC fault to a servicing dealer. The HVAC analytics engine analyzes historical HVAC operational data and interacts with dealer (and/or homeowner), to support the dealer's recommendation for service and provide more effective and productive servicing of the HVAC equipment. The fault detection system can provide real time information of HVAC system performance, generate alerts when the performance degradation occurs. All of the above could help dealer provide quick response to the homeowner, even before the homeowner makes a service call.

With reference now to FIG. 1, a block diagram illustrates an HVAC network 200 in accordance with one or more non-limiting embodiments. The HVAC network 200 is in electronic communication with an HVAC system 201 that includes one or more HVAC units 202. Although a single HVAC unit 202 is illustrated, it should be appreciated that the HVAC system 201 can include additional HVAC units. For example, the HVAC unit 202 may be included in a group of HVAC units. An HVAC group may include additional HVAC units (not shown) located at different areas of a building or house, or even in a different home.

The HVAC unit 202 is in electronic communication with a computing system 100. The computing system 100 can be installed in the HVAC system 201 or wirelessly connected to the HVAC system through the computing network 206 while being installed on a separate server 212 or a user device 210. The computing system 100 includes a memory 102 and an electronic hardware processor or controller 106. The memory 102 stores various instructions algorithms which are executable by the controller 106. The memory 102 can also store set operating schedules, HVAC unit characteristics 354, and historical HVAC data 352 obtained from HVAC unit 202 (see FIG. 2).

The HVAC unit 202 is in electronic communication with the controller 106 such as, for example, a digital thermostat. Although one controller 106 is illustrated, it should be appreciated that multiple controllers can be located remotely from one another. Each controller 106 can control the HVAC unit 202. The controller 106 can perform various functions including, but not limited to, switching on and off the HVAC unit 202, selecting a mode (e.g., heating mode, cooling mode, etc.) of the HVAC unit 202, setting a desired room temperature at which to operate the HVAC unit 202, and setting operating schedules at which to operate the HVAC unit 202. The controller 106 includes a digital thermostat, for example, configured to control operation of the HVAC unit 202. The controller 106 is also in electronic communication with one or more sensors configured to detect and monitor various conditions such as, for example, room temperatures and humidity. In this manner, the controller 106 can actively control the HVAC unit 202 to achieve and/or maintain a room temperature set point value and/or set according to an operating schedule. The controller 106 is also configured to monitor operation of the HVAC unit 202. In this manner, the controller 106 can generate operation HVAC data 352 (see FIG. 2) based on the conditioned air produced to achieve and maintain the target temperature setpoint. The operation data includes, but is not limited to HVAC unit start times, stop times, run time duration, and temperature settings with respect to a time of day.

The controller 106 may electrically communicate with the memory 102 via one or more input/output (I/O) devices 108. In some embodiments, the I/O device(s) 108 may include one or more of a keyboard or keypad, a touchscreen or touch panel, a display screen, a microphone, a speaker, a mouse, a button, a remote control, a joystick, a printer, a telephone or mobile device (e.g., a smartphone), sensors such as temperature, pressure and occupancy, etc. The I/O device(s) 108 may be configured to provide an interface such as a thermostat interface, for example, to allow a user to interact with the computing system 100.

The computing system 100 further includes a network interface 110 capable of communication with a network 206. The network 206 can be implemented as a local on-site network data network, a computer network, a telephone network, a cloud computing network, etc. The network interface 110 includes any communication device (e.g., a modem, wireless network adapter, etc.) that operates according to a network protocol (e.g., Wi-Fi, Ethernet, satellite, cable communications, etc.) which establishes a wired and/or wireless communication with the network 206. The network 206 may be in electronic communication with one or more electronic user devices 210 and various servers 212. For example, weather data 370 (see FIG. 2) may be obtained from the various servers 212 through the network 206.

The user devices 210 include, but are not limited to, a desktop computer, a laptop computer, and a mobile device (e.g., a cell phone, smartphone, smart wearable device, etc.). The user device 210 also includes a display unit, which can display HVAC performance reports 320 (see FIG. 2). In some embodiments, the controller 106 may communicate with a user device 210 via the network 206. In some embodiments, the controller 106 may communicate directly with the user device 210. For instance, the controller 106 may be capable of communicating directly with the user device 210 via a short-range communication protocol such as, for example, Bluetooth.

Turning now to FIG. 2 with continued reference to FIG. 1, an HVAC analytics system 300 is illustrated according to a non-limiting embodiment. The HVAC analytics system 300 includes an HVAC system 201 in electronic communication with computing network 206 which employs an HVAC analytics engine 306. The computing network 206 can include a cloud-based network, and the HVAC analytics engine 306 can be a cloud-based HVAC analytics engine 306 installed in the cloud network 206 that includes a processor and a memory. The HVAC analytics engine 306 can also be stored locally stored, e.g., implemented in the local controller 106 (e.g., digital thermostat of the HVAC system 201). The computing network 206 and HVAC analytics engine 306 may also be in electronic communication with one or more user devices 210.

In at least one embodiment, the HVAC system 201 sends HVAC Data 352 and HVAC unit characteristics 354 to the HVAC analytics engine 306. The HVAC unit characteristics 354 include the type of HVAC unit 202, the performance rating data of the HVAC unit 202 (e.g., the performance rating maximum rated output performance per units of energy consumed), target area (i.e. room(s)) to be heated/cooled, the number of total HVAC units 202 per targeted area, cooling capacity, heating capacity, and a geographical location of the HVAC system 201. The HVAC unit characteristics 354 may also include updated HVAC equipment information, which can indicate whether a new HVAC unit 202 has been installed in the HVAC system 201.

The HVAC analytics engine 306 includes an HVAC data processing module 310, an HVAC data learning module 312, an HVAC Health performance index calculation module 314, and an HVAC reporting module 316. Any one of the HVAC data processing module 310, the HVAC data learning module 312, the HVAC Health performance index calculation module 314, and the HVAC reporting module 316 can be constructed as an electronic hardware controller that includes memory and a processor configured to execute algorithms and/or computer-readable program instructions stored in the memory.

The HVAC data processing module 310 is configured to pre-process the raw HVAC data 352 from the controller 106 with the purpose to extract the essence (i.e. useful information) from data and remove the dross (i.e. data noise and useless information data). The raw HVAC data 352 may include HVAC information such as, for example, outdoor air temperature (OAT), indoor air temperature (TAT), HVAC set point, user inputs, geographical location of the HVAC system 201, HVAC unit running time, power usage (e.g., kW per hour), cooling capacity (e.g., kW per hour), gas usage (e.g., kW per hour), heating capacity e.g., (Kw per hour), set temperature per hour, and actual room temperature per hour. The HVAC analytics engine 306 may perform a first loop from the HVAC data processing module 310 to the HVAC reporting module 316 when severe faults are observed from the HVAC data 352 such as an indoor comfort issue or an HVAC unexpected shut-down in two non-limiting examples. The HVAC analytics engine 306 may perform a second loop from the HVAC data processing module 310 to the HVAC data learning module 312, the HVAC Health performance index calculation module 314, and the HVAC reporting module 316.

The HVAC data learning module 312 is configured to determine (i.e. learn) dynamic system behavior and/or static system behavior based on defined system model (i.e. formulas) having performance parameters that need be identified and calibrated against HVAC data 352 from the HVAC data processing module 310. As seen in Eq. 1 and Eq. 2, the performance parameters may include A₁, A₂, A₃, A₃, B, and C, which are discussed further below.

Output of the HVAC data learning module 312 is an identified/calibrated system model. The system behavior may change when a fault occurs which may reflect in the performance parameters in the system model. The system model may include a system dynamic model (see Eq. 1) and a system static model (see Eq. 2). The system dynamic model (see Eq. 1) captures system behavior at shorter time periods (e.g., 5 minutes), whereas the system static model (see Eq. 2) captures system behavior at longer time periods (e.g., average behavior per day).

IART(t)=A₁·(IAT−OAT)+A₂·Cap(t)+A₃·Cap(t−1)+A₄·IATR(t−1)+C [Eq. 1]

Cap=A·(IAT−OAT)+B [Eq. 2]

The system dynamic model illustrated by Eq. 1 calculates an indoor air temperature change rate (IATR) which is an indicator of performance of the HVAC unit 202. If some capacity related fault happens to HVAC system 201, the HVAC system 201 is not able to provide as much capacity as usual, then IATR will approach 0 or even reverse, leading to indoor temperature comfort out of control. In cooling mode, IATR goes from a negative value to 0 or even becomes positive (indoor temperature cannot be maintained). In heating mode, IATR goes from a positive value to 0 or even becomes negative. Performance parameters involved in the IATR calculation include the indoor air temperature (IAT), the outdoor air temperature (OAT), the capacity of the HVAC system (Cap), time (t), A₁, A₂, A₃, A₃, and C. The parameter A₁ is the impact of difference in IAT and OAT on IATR. The parameter A₂ and A₃ are the impact of capacity on IATR and the time lag between capacity and IATR are considered. The parameter C is the overall impact of all other factors such as solar, internal load, people activity, etc. The system static model illustrated by Eq. 2 calculates the Cap. Variables involved in the Cap calculation include the indoor air temperature (IAT), the outdoor air temperature (OAT), A, and B. Parameters A impact of the difference between IAT and OAT on house load and parameter C is the impact of all other factors such as solar, internal load, people activity, etc.

The HVAC Health performance index calculation module 314 is configured to calculate HVAC performance indices at defined standard condition using the system model identified/calibrated by the HVAC data learning module 312. The HVAC performance indices representing the HVAC health status include: a Capacity Available Ratio (CAR) (see Eq. 3); a Comfort OAT limit (see Eq. 4); an IATR (see Eq. 5); and an IAT limit (see Eq. 6).

$$\begin{matrix}CAR = \frac{{Cap}_{HVACMAP} ( {IAT}_{std} , {OAT}_{std} )}{- \frac{{A}_{1} \cdot ( {IAT}_{std} - {OAT}_{std} ) + C}{{A}_{2} + {A}_{3}}} & [ Eq . 3 ] \\ {Cap}_{HVACMAP} ( {IAT}_{std} , {OAT}_{lmt} ) = A \cdot ( {IAT}_{std} - {OAT}_{lmt} ) + B & [ Eq . 4 ] \\ {IATR}_{std} = ( {A}_{2} + {A}_{3} ) \cdot {Cap}_{HVACMAP} ( {IAT}_{std} , {OAT}_{std} ) & [ Eq . 5 ] \\ {Cap}_{HVACMAP} ( {IAT}_{lmit} , {OAT}_{std} ) = A \cdot ( {IAT}_{lmt} - {OAT}_{std} ) + B & [ Eq . 6 ]\end{matrix}$$

The CAR of Eq. 3 is a ratio of HVAC available capacity versus the target area required capacity for comfort. Eq. 3 calculates the ratio of HVAC available capacity to the target area load at defined standard conditions which represents how much excess capacity the HVAC system 201 has as compared to target area load (e.g., CAR=1 means zero excess capacity and CAR=1.2 mean 20% excess capacity).

The Comfort OAT limit of Eq. 4 is the minimum/maximum OAT which the HVAC system 201 can maintain indoor setpoint. Eq. 4 is an implicit expression to calculate a Comfort OAT limit above/below, which determines whether there will be indoor comfort issues during cooling/heating mode. The IATR of Eq. 5 is the speed that HVAC system 201 is able to pull down/up the IAT. Eq. 5 calculates IATR at a defined standard condition. The IAT limit of Eq. 6 is the minimum/maximum IAT that the HVAC system 201 is able to cool/heat to within the interior space. Eq. 6 is an implicit expression to calculate an IAT limit, which means the achievable IAT with full HVAC capacity at a defined outdoor condition.

The HVAC reporting module 316 is also configured to generate one or more HVAC performance reports 320 in response to the performance indices calculated by the HVAC Health performance index calculation module 314. The HVAC reporting module 316 also generates and transmits HVAC performance reports 320 to the user device 210 if at least one of the calculated performance indices and/or change rate trigger some threshold. The user device 210 also includes a display unit which can display HVAC performance reports 320. The HVAC performance reports 320 may help support a dealer's decision on HVAC service. The HVAC reporting module 316 generates an alert if at least one of the calculated performance indices and/or change rate are outside a selected range.

In the example illustrated in FIG. 2, the IATR shows that the HVAC system 201 has experienced a greater than 20% capacity loss from an initial baseline in mid-summer 2016, thus a HVAC performance report 320 may be generated and transmitted to the user device 210 in order to alert the dealer that a pre-emptive check-up may be necessary for the HVAC system 201. An alert may be generated to draw attention to the IATR predicting capacity loss of the HVAC system 201.

The HVAC reporting module 316 is also configured to generate one or more HVAC performance reports 320. The HVAC performance reports may depict the IATR and CAR values in various graphical renderings. In each rendering, the IATR is the measure of “Performance” of the HVAC system 201 and CAR is the measure of “Sizing” of the HVAC system 201. The HVAC reporting module 316 tracks the HVAC performance index over time and triggers a flag if the HVAC performance index is beyond the defined threshold. An alert will generate if multiple flags are triggered within a period of time.

Referring now also to FIG. 3 with continued reference to FIGS. 1-2. FIG. 3 shows a flow diagram illustrating a method 400 of operating an HVAC analytics system 300, according to an embodiment of the present disclosure. As described above HVAC analytics system 300 may be a cloud-based system and/or the HVAC analytics system 300 may be incorporated into the controller 106 of an HVAC system 201.

At block 402, HVAC data 352 of the HVAC system 201 is obtained. The HVAC data 352 can be obtained from the HVAC controller 106, and can be communicated to the HVAC analytics engine 306 in real-time, and/or can be delivered in response to a data request sent by the HVAC analytics engine 306. The HVAC data 353 includes, for example, OAT, IAT, HVAC set point, user inputs, geographical location, HVAC unit running time, set temperature per hour, and actual room temperature per hour. The user inputs may include the type of HVAC system 201 (air conditioner, gas furnace, electric heater, heat pump, geothermal, etc.), if that information cannot be obtained from the HVAC controller.

At block 404, HVAC unit characteristics 354 of the HVAC system 201 are obtained. The HVAC unit characteristics 354 can be obtained from the HVAC controller 106, and can be communicated to the HVAC analytics engine 306 in real-time, and/or can be delivered in response to a data request sent by the HVAC analytics engine 306. In another embodiment, the HVAC unit characteristics 354 can be obtained from a separate server 212 (e.g. the server 212 is configured to store the HVAC unit characteristics 354 for each HVAC system 201), and can be communicated to the HVAC analytics engine 306 in real-time, and/or can be delivered in response to a data request sent by the HVAC analytics engine 306.

At block 406, performance parameters are determined (i.e., learned) for the system models (e.g. EQ. 1-2) and the HVAC performance indices (e.g. EQ. 3-6) in response to the HVAC data 352 and the HVAC unit characteristics 354. At block 408, the systems models for the HVAC system 201 may be identified/calibrated in response to the performance parameters determined in block 406. At block 410, the HVAC performance indices (e.g. EQ. 3-6) are calculated at defined standard conditions using the system models identified/calibrated at block 408, the HVAC data 352, and the HVAC unit characteristic 354.

At block 412, one or more HVAC performance reports 320 are generated in response to the HVAC performance indices. The HVAC performance reports 320 include various analytical data predicting performance of the HVAC system 201 over a period of time. At block 414, the HVAC performance reports 320 are transmitted to a user device 210 in electronic communication with the computing network. The reports can be displayed via the user device 210 such that a user (e.g., dealer, maintainer, or homeowner) is able to monitor the operating performance of the HVAC system 201.

While the above description has described the flow process of FIG. 3 in a particular order, it should be appreciated that unless otherwise specifically required in the attached claims that the ordering of the steps may be varied.

As used herein, the term “module” or “unit” can refer to an application specific integrated circuit (ASIC), an electronic circuit, a microprocessor, a computer processor (shared, dedicated, or group) and memory that executes one or more software or firmware programs, a combinational logic circuit, a microcontroller including various inputs and outputs, and/or other suitable components that provide the described functionality. The module is configured to execute various algorithms, transforms, and/or logical processes to generate one or more signals of controlling a component or system. When implemented in software, a module can be embodied in memory as a non-transitory machine-readable storage medium readable by a processing circuit (e.g., a microprocessor) and storing instructions for execution by the processing circuit for performing a method. A controller refers to an electronic hardware controller including a storage unit capable of storing algorithms, logic or computer executable instruction, and that contains the circuitry necessary to interpret and execute instructions.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes a device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of operating a heating, ventilation, and air conditioning (HVAC) analytics system, the method comprising:
obtaining HVAC data for an HVAC unit;
obtaining an HVAC unit characteristic of the HVAC unit;
determining performance parameters of the HVAC unit in response to the HVAC data and the HVAC unit characteristic;
identifying one or more system models for the HVAC unit in response to the performance parameters;
determining one or more HVAC performance indices in response to the one or more system models, HVAC data, and the HVAC unit characteristic;
generating an HVAC performance report in response to the one or more performance indices; and
transmitting the HVAC performance report to a user device.

2. The method of claim 1, further comprising:
activating an alarm when at least one of the one or more performance indices is outside of a selected range.

3. The method of claim 1, wherein:
the one or more HVAC performance indices includes an indoor air temperature rate.

4. The method of claim 3, wherein:
the HVAC performance reports includes the indoor air temperature rate over a selected period of time.

5. The method of claim 1, wherein:
the one or more system models includes at least one of a system static model and a system dynamic model.

6. The method of claim 1, wherein:
the one or more HVAC performance indices includes at least one of a capacity available ratio (CAR), a comfort outdoor air temp (OAT) limit, an indoor air temperature rate (IATR), and an IAT limit.

7. The method of claim 1, wherein:
the HVAC data includes at least one of an IATR produced by the HVAC unit, an OAT proximate the HVAC unit, and a runtime of the HVAC unit.

8. A heating, ventilation, and air conditioning (HVAC) analytics system comprising:
an HVAC system comprising an HVAC unit and a controller configured to deliver conditioned air to a targeted area;
an HVAC analytics engine in electronic communication with the HVAC system, the HVAC analytics engine comprising a processor, and a memory, the HVAC analytics engine configured to:
obtain HVAC data;
obtain an HVAC unit characteristic of the HVAC unit;
determine performance parameters of the HVAC unit in response to the HVAC data and the HVAC unit characteristic;
identify one or more system models for the HVAC unit in response to the performance parameters;
determine one or more HVAC performance indices in response to the one or more system models, HVAC data, and the HVAC unit characteristic;
generate an HVAC performance report in response to the one or more performance indices; and
transmit the HVAC performance report to a user device.

9. The HVAC analytics system of claim 8, wherein the HVAC analytics engine is further configured to:
activate an alarm when at least one of the one or more performance indices is outside of a selected range.

10. The HVAC analytics system of claim 8, wherein:
the one or more HVAC performance indices includes an indoor air temperature rate.

11. The HVAC analytics system of claim 10, wherein:
the HVAC performance reports includes the indoor air temperature rate over a selected period of time.

12. The HVAC analytics system of claim 8, wherein:
the one or more system models includes at least one of a system static model and a system dynamic model.

13. The HVAC analytics system of claim 8, wherein:
the one or more HVAC performance indices includes at least one of a capacity available ratio (CAR), a comfort outdoor air temp (OAT) limit, an indoor air temperature rate (IATR), and an IAT limit.

14. The HVAC analytics system of claim 8, wherein:
the HVAC data includes at least one of an IATR produced by the HVAC unit, an OAT proximate the HVAC unit, and a runtime of the HVAC unit.

15. The HVAC analytics system of claim 8, wherein:
the HVAC analytics engine is separate and apart from the HVAC unit, and
wherein the HVAC analytics engine is in electronic communication through a wireless communication network.

16. The HVAC analytics system of claim 8, wherein:
the HVAC analytics engine is embedded within at least one of the HVAC unit and a controller in communication with the HVAC unit.

17. A computer program product tangibly embodied on a computer readable medium, the computer program product including instructions that, when executed by a processor, cause the processor to perform operations comprising:
obtaining HVAC data for an HVAC unit;
obtaining an HVAC unit characteristic of the HVAC unit;
determining performance parameters of the HVAC unit in response to the HVAC data and the HVAC unit characteristic;
identifying one or more system models for the HVAC unit in response to the performance parameters;
determining one or more HVAC performance indices in response to the one or more system models, HVAC data, and the HVAC unit characteristic;
generating an HVAC performance report in response to the one or more performance indices; and
transmitting the HVAC performance report to a user device.

18. The computer program product of claim 17, wherein the operations further comprise:
activating an alarm when at least one of the one or more performance indices is outside of a selected range.

19. The computer program product of claim 17, wherein:
the one or more HVAC performance indices includes an indoor air temperature rate.

20. The computer program product of claim 19, wherein:
the HVAC performance reports includes the indoor air temperature rate over a selected period of time.
